(19) United States
(12) Patent Application Publication
(10) Pub. No.: US 2021/0291379 A1
(43) Pub. Date: Sep. 23, 2021

(54) ROBOT, SPEECH SYNTHESIZING PROGRAM, AND SPEECH OUTPUT METHOD

(71) Applicant: GROOVE X, INC., Tokyo (JP)

(72) Inventors: Kaname HAYASHI, Tokyo (JP); John BELMONTE, Tokyo (JP); Atsuya KOSE, Tokyo (JP); Masaya MATSUURA, Tokyo (JP)

(21) Appl. No.: 17/337,359

(22) Filed: Jun. 2, 2021

Related U.S. Application Data
(63) Continuation of application No. PCT/JP2019/046895, filed on Nov. 29, 2019.

(30) Foreign Application Priority Data
Dec. 3, 2018 (JP) 2018-226489

(51) Int. Cl. B25J 11/00; G10L 15/187; G10L 15/20; G10L 13/08; G10L 13/027

(52) U.S. Cl. CPC B25J 11/001; G10L 15/187; G10L 13/027; G10L 13/08; G10L 15/20

(57) ABSTRACT

An object of the invention is to carry out communication wherein linguistic communication is reduced during speech communication with another party carried out by a robot outputting speech. A robot includes a sensing unit that senses an external environment and generates an input signal, a phoneme acquisition unit that acquires first phonological information formed of a multiple of phonemes based on the input signal, a phoneme generating unit that generates second phonological information differing from the first phonological information based on at least one portion of phonemes included in the first phonological information, a speech synthesizing unit that synthesizes speech in accordance with the second phonological information, and a speech output unit that, outputs the speech.

### CROSS-REFERENCE TO RELATED APPLICATIONS

The present application is a continuation of International Application No. PCT/JP2019/C46895, filed Nov. 29, 2019, which claims priority from Japanese Application No. 2018-226489, filed Dec. 3, 2018, the disclosures of which applications are hereby incorporated by reference herein in their entirety.

### BACKGROUND OF THE INVENTION

### 1. Field of the Invention

The present invention relates to a robot that, outputs speech, a speech synthesizing program, and a speech output method.

### 2. Description of the Background Art

When a robot outputs speech in accordance with a stimulus from a user (for example, talking or contact) or an internal parameter (for example, an emotion parameter), the user can experience a sense that the robot has its own will, and can feel affection toward the robot.

In addition to linguistic information, paralinguistic information is included in speech. Linguistic information is phonological information that expresses a concept, while paralinguistic information is non-linguistic information such as a tone or a meter (speech pitch, intonation, rhythm, pause, and the like). It is known that a user can obtain a healing effect by carrying out non-linguistic communication, as with animal therapy or the like, but non-linguistic communication using paralinguistic information is also included, in addition to linguistic communication using linguistic information, in communication using speech as well, and by effectively utilizing this non-linguistic communication in a robot speech output, a user can be provided with solace (for example, refer to JP-A-2018-128690).

Meanwhile, linguistic communication between a robot and a user is enriched by the robot expressing some concept (an emotion, an intention, a meaning, or the like) using linguistic information in speech, and the user feels affection toward the robot.

However, when a robot carries out linguistic communication including linguistic information that is too clear in speech communication with a user carried out by outputting speech, the robot's speech is felt to be persuasive and explanatory by the user, and the healing effect obtained from non-linguistic communication decreases.

Also, linguistic communication is not essential in speech communication between robots, and a user watching that can be provided with solace by a conversation that does not use linguistic communication being carried out.

### SUMMARY OF THE INVENTION

Therefore, the invention has an object of promoting a formation of affection from a user toward a robot during speech communication with another party carried out by the robot outputting speech.

A robot of one aspect of the invention includes a phoneme acquisition unit that acquires first phonological information formed of a multiple of phonemes, a phoneme generating unit that generates second phonological information differing from the first phonological information based on at least one portion of phonemes included in the first phonological information, a speech synthesizing unit that synthesizes speech in accordance with the second phonological information, and a speech output unit that outputs the speech.

Also, a speech synthesizing program of one aspect of the invention causes a robot computer to function as a phoneme acquisition unit that acquires first phonological information formed of a multiple of phonemes, a phoneme generating unit that generates second phonological information differing from the first phonological information based on at least one portion of phonemes included in the first phonological information, and a speech synthesizing unit that synthesizes speech in accordance with the second phonological information.

Also, a speech output method of one aspect of the invention is a robot speech output method, and includes a phoneme acquisition step of acquiring first phonological information formed of a multiple of phonemes, a phoneme generation step of generating second phonological information differing from the first phonological information based on at least one portion of phonemes included in the first phonological information, a speech synthesizing step of synthesizing speech in accordance with the second phonological information, and a speech output step of outputting the speech.

According to the invention, a phoneme generating unit generates second phonological information based on at least one portion of phonemes included in acquired first phonological information. A speech synthesizing unit synthesizes speech in accordance with this kind of second phonological information. Because of this, a formation of affection from a user toward a robot can be promoted during speech communication with another party carried out by the robot outputting speech.

### BRIEF DESCRIPTION OF THE DRAWINGS

The heretofore described object, and other objects, characteristics, and advantages, will be further clarified by a preferred embodiment described hereafter, and by the following accompanying drawings.

FIG. 1A is a front external view of a robot of an embodiment of the invention;

FIG. 1B is a side external view of the robot of the embodiment of the invention;

FIG. 2 is a sectional view schematically showing a structure of the robot of the embodiment of the invention;

FIG. 3 is a drawing showing a hardware configuration of the robot of the embodiment of the invention;

FIG. 4 is a block diagram showing a configuration for outputting speech of the robot of the embodiment of the invention;

FIG. 5 is a block diagram showing in detail configurations of a letter sequence input unit, a sensing unit, and an acquisition unit of the embodiment of the invention;

FIG. 6 is an example of a phoneme-emotion table that stipulates a relationship between a phoneme and an emotion parameter in the embodiment of the invention;

FIG. 7 is a block diagram showing in detail configurations of a generating unit, a speech synthesizing unit, and an output unit of the embodiment of the invention;

FIG. 8A is a drawing showing an example of a metrical curve used by the speech synthesizing unit of the embodiment of the invention;

FIG. 8B is a drawing showing an example of a metrical curve used by the speech synthesizing unit of the embodiment of the invention;

FIG. 8C is a drawing showing an example of a metrical curve used by the speech synthesizing unit of the embodiment of the invention;

FIG. 8D is a drawing showing an example of a metrical curve used by the speech synthesizing unit of the embodiment of the invention; and

FIG. 9 is a drawing showing an example of two metrical curves linked by the speech synthesizing unit of the embodiment of the invention.

### DETAILED DESCRIPTION OF THE INVENTION

Hereafter, an embodiment of the invention will be described. The embodiment described hereafter shows one example of a case in which the invention is implemented, and the invention is not limited to a specific configuration described hereafter. A specific configuration that accords with the embodiment may be employed as appropriate when implementing the invention.

A robot of the embodiment of the invention includes an acquisition unit that acquires first phonological information formed of a multiple of phonemes, a generating unit that generates second phonological information differing from the first phonological information based on at least one portion of phonemes included in the first phonological information, a speech synthesizing unit that synthesizes speech in accordance with the second phonological information, and an output unit that outputs the speech.

According to this configuration, firstly, the robot synthesizes speech in accordance with phonological information, and outputs the speech, rather than outputting speech by reproducing a sound source prepared in advance. Further, the robot generates second phonological information that, although based on at least one portion of phonemes in the acquired first phonological information, differs from the first phonological information, and the speech synthesizing unit synthesizes speech in accordance with the second phonological information generated in such a way. This means that even when, for example, speech is output by copying first phonological, information acquired using speech sensing, second phonological information wherein a change has been made to one portion of phonemes can be generated. Because of this, an imperfect mimicking (speech imitation) can be realized, cuteness of the robot increases, and a formation of affection from a user toward the robot can be promoted. Also, when a conversation is conducted between robots, first phonological information is acquired from speech of the other robot, and speech is synthesized in accordance with second phonological information differing from the first phonological information, and output the speech. Because of this, the conversation can be continued by the two robots conducting the conversation executing the process. By extension, a formation of affection from a user toward the robots can be promoted.

The phoneme generating unit may generate the second phonological information to include linguistic information of an amount smaller than that of linguistic information included in the first phonological information.

According to this configuration, second phonological information is generated by reducing the amount of linguistic information included in acquired first phonological information, because of which speech communication of a degree equivalent to that of, for example, an infant with immature speech capability can be realized. A method of reducing the amount of linguistic information included in first phonological information may be, for example, a partial deletion of, a partial change to, or a partial addition to a text or a phoneme with respect to a phoneme of the first phonological information.

The robot may further include a sensing unit that generates an input signal by sensing an external environment, and the phoneme acquisition unit may acquire the first phonological information based on the input signal.

The sensing unit may be a microphone that senses a sound and generates a speech signal as the input signal, and the phoneme acquisition unit may fix the linguistic information based on the speech signal, and acquire the first phonological information including the linguistic information.

The phoneme acquisition unit may carry out speech recognition with respect to the speech signal, and acquire the first phonological information that has the recognized speech as the linguistic information.

According to this configuration, a robot can realize an imperfect mimicking wherein speech heard is repeated imperfectly copied. For example, when a user says “satsuma” to the robot, the robot acquires first phonological information including the linguistic information “satsuma”. The robot generates second phonological information including the linguistic information “tatsuma”, wherein a consonant of “satsuma” has been replaced, and outputs the second phonological information as speech. Because of this, a user, while understanding that the robot is attempting to repeat “satsuma” parrot-fashion, can feel cuteness in the imperfect mimicry.

The phoneme acquisition unit may carry out speech recognition with respect to the speech signal, and acquire the first phonological information that has a response to the recognized speech as the linguistic information.

According to this configuration, a robot can realize a conversation wherein the robot responds to speech heard using an imperfect linguistic expression, a user can understand the response expressed by the robot, and the cuteness of the robot increases. For example, when the robot obtains first phonological information including the linguistic information “cuddle” as a response to a user asking the robot “What shall we do?”, second phonological information “cu' le”, wherein the double consonant sound has been deleted from “cuddle”, is generated and output as speech. Because of this, the user, while understanding that the robot is asking for a “cuddle”, can feel cuteness from the imperfect linguistic expression.

The sensing unit may be a camera that senses incident light and generates an image signal as the input signal, and the phoneme acquisition unit may fix the linguistic information based on the image signal, and acquire the first phonological information including the linguistic information.

The phoneme acquisition unit may carry out text recognition with respect to the image signal, and acquire the first phonological information including recognized text as the linguistic information.

According to this configuration, a robot does not vocalize text recognized by sight as it is, but instead vocalizes the text using an imperfect linguistic expression. A user can understand that the robot is attempting to read text that the robot has seen, and the cuteness of the robot increases For example, when the robot acquires first phonological information including the linguistic information “clock” by recognizing text from an image signal, second phonological information “clo'”, wherein a portion of the text of “clock” has been deleted, is generated and output as speech. Because of this, the user, while understanding that the robot is attempting to read the text “clock”, can feel cuteness from the imperfect linguistic expression.

The phoneme acquisition unit may carry out object recognition with respect to the image signal, and acquire the first phonological information including linguistic information that represents a recognized object.

According to this configuration, a robot does not express a recognized object as it is, but instead expresses the object using imperfect linguistic information, because of which a user can understand that the robot is attempting to express a recognized object, and the cuteness of the robot increases. For example, when the robot recognizes a clock by carrying out object recognition with respect to an image signal, and acquires first phonological information including the linguistic information “clock”, second phonological information including the linguistic information “clo'”, wherein a portion of the text of “clock” has been deleted, is generated and output as speech. Because of this, the user, while understanding that the robot has recognized a “clock”, can feel cuteness from the imperfect linguistic expression.

The phoneme generating unit may identify an emotion parameter corresponding to the at least one portion of phonemes of the first phonological information, and generate the second phonological information based on the identified emotion parameter.

According to this configuration, a robot generates second phonological information based on an emotion parameter corresponding not to linguistic information in acquired first phonological information, but to a phoneme thereof, because of which non-linguistic communication can be realized. This non-linguistic communication is such that an amount of linguistic information in first phonological information and second phonological information may be scant, for example, a meaningless phonological sequence such as onomatopoeia (for example, “oo, oo”).

The phoneme generating unit may generate the second phonological information including an emotion parameter close to the emotion parameter.

The robot may further include a table that stipulates a relationship between a phoneme and an emotion parameter, and the phoneme generating unit may refer to the table, and identify an emotion parameter corresponding to the at least one portion of phonemes of the first phonological information.

The robot may further include a table that stipulates a relationship between a phoneme and an emotion parameter, and the phoneme generating unit may refer to the table, and generate second phonological information.

The robot may further include a microphone that generates a speech signal by sensing a sound, and the phoneme acquisition unit may acquire first phonological information by carrying out speech recognition with respect to the speech signal.

The phoneme generating unit may generate the second phonological information formed of a predetermined number or less of syllables (for example, two syllables), regardless of a number of syllables in the first phonological information.

Also, a speech synthesizing program of one aspect of the invention, by being executed by a robot computer, causes the robot computer to function as a phoneme acquisition unit that acquires first phonological information formed of a multiple of phonemes, a phoneme generating unit that generates second phonological information differing from the first phonological information based on at least one portion of phonemes included in the first phonological information, and a speech synthesizing unit that synthesizes speech in accordance with the second phonological information.

Also, a speech output method of one aspect of the invention is a robot speech output method, and includes a phoneme acquisition step of acquiring first phonological information formed of a multiple of phonemes, a phoneme generation step of generating second phonological information differing from the first phonological information based on at least one portion of phonemes included in the first phonological information, a speech synthesis step of synthesizing speech in accordance with the second phonological information, and a speech output step of outputting the speech.

Hereafter, a robot of the embodiment will be described with reference to the drawings.

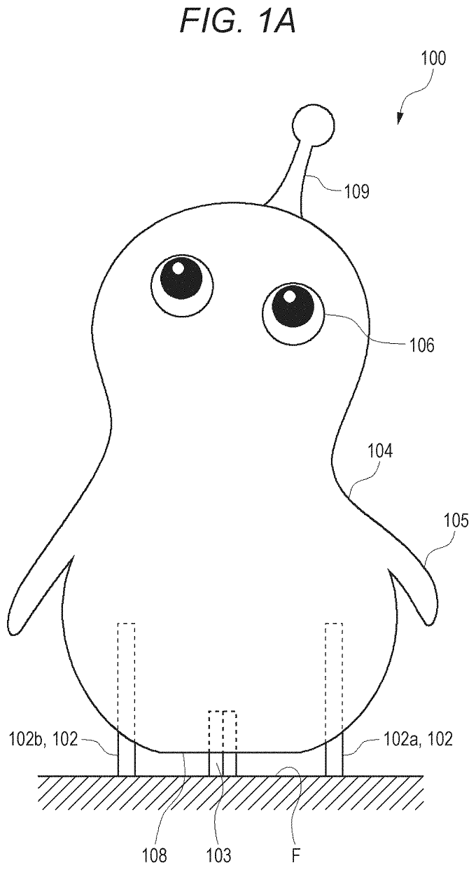

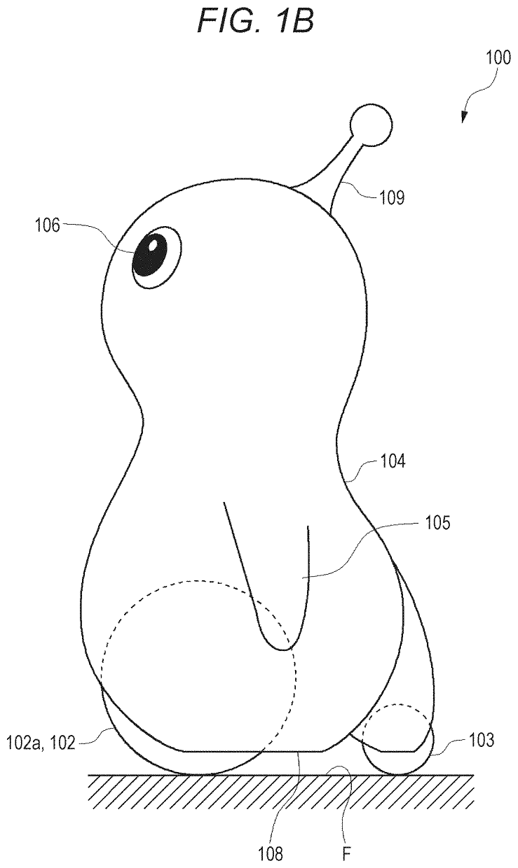

FIG. 1A is a front external view of a robot, and FIG. 1B is a side external view of the robot. A robot 100 in the embodiment is an autonomously acting robot that fixes an action, a gesture, or speech based on an external environment and an internal state. The external environment is detected by a sensor group including a camera, a microphone, an acceleration sensor, a touch sensor, and the like. The internal state is quantified as various parameters that express emotions of the robot 100.

The robot 100 has, for example, a familiarity parameter for each user as a parameter expressing emotion. When an action indicating a liking toward the robot 100, such as picking the robot 100 up or speaking to the robot 100, is performed, the robot 100 detects the action using the sensor group, and increases familiarity with respect to that user. Meanwhile, the robot 100 reduces familiarity with respect to a user not involved with the robot 100, a user who behaves roughly, a user met infrequently, and the like.

A body 104 of the robot 100 has a rounded form all over, and includes an outer skin formed of a soft material having elasticity, such as urethane, rubber, a resin, or a fiber. A weight of the robot 100 is 15 kilograms or less, preferably 10 kilograms or less, and more preferably still 5 kilograms or less. Also, a height, of the robot 100 is 1.2 meters or less, or preferably 0.7 meters or less. In particular, owing to size and weight, being reduced by the weight being in the region of 5 kilograms or less and the height being in the region of 0.7 meters or less, a user, including a child or an elderly person, can easily hug the robot 100, which is desirable.

The robot 100 includes three wheels for three-wheeled traveling. The robot 100 includes a pair of front, wheels 102 (a left wheel 102a and a right wheel 102b) and one rear wheel 103, as shown in the drawings. The front wheels 102 are drive wheels, and the rear wheel 103 is a driven wheel. Although the front wheels 102 have no steering mechanism, a rotational speed and a direction of rotation of the left wheel 102a and the right wheel 102b can be individually controlled.

The rear wheel 103 is a so-called omni wheel or a caster, and rotates freely in order to cause the robot 100 to move forward and back, and left and right. By controlling so that the rotational speed in a forward direction of the right wheel 102b is greater than that of the left wheel 102a (including a case wherein the left wheel 102a is stationary or rotating in a backward direction), the robot 100 can turn left or rotate counterclockwise. Also, by controlling so that the rotational speed in a forward direction of the left wheel 102a is greater than that of the right wheel 102b (including a case wherein the right wheel 102b is stationary or rotating in a backward direction), the robot 100 can turn right or rotate clockwise.

The front wheels 102 and the rear wheel 103 can be completely housed in the body 104 using a drive mechanism. A greater portion of each wheel is hidden by the body 104 when traveling too, but when each wheel is completely housed in the body 104, the robot 100 is in a state of being unable to move. That is, the body 104 descends in accompaniment to an operation of the wheels being housed, and the robot 100 sits on a floor surface F. In the sitting state, a flat seating face 108 (a setting bottom face) formed in a bottom portion of the body 104 comes into contact with the floor surface F, and the robot 100 can stably maintain the sitting state.

The robot 100 has two arms 105. The robot 100 is capable of actions such as raising, waving, and oscillating the arm 105. The two arms 105 can be individually controlled.

An image can be displayed in an eye 106 using a display device formed of an element such as a liquid crystal element or an organic EL element. The robot 100 includes various sensors, such as a microphone or an ultrasonic wave sensor that can identify a sound source direction, a smell sensor, a distance sensor, and an acceleration sensor. Also, the robot 100 incorporates a speaker, and can output speech. A capacitive touch sensor is installed in the body 104 of the robot 100. The robot 100 can detect a touch by a user using the touch sensor.

A horn 109 is attached to a head portion of the robot 100. An omnidirectional camera is attached to the horn 109, and can film all regions above the robot 100 at one time.

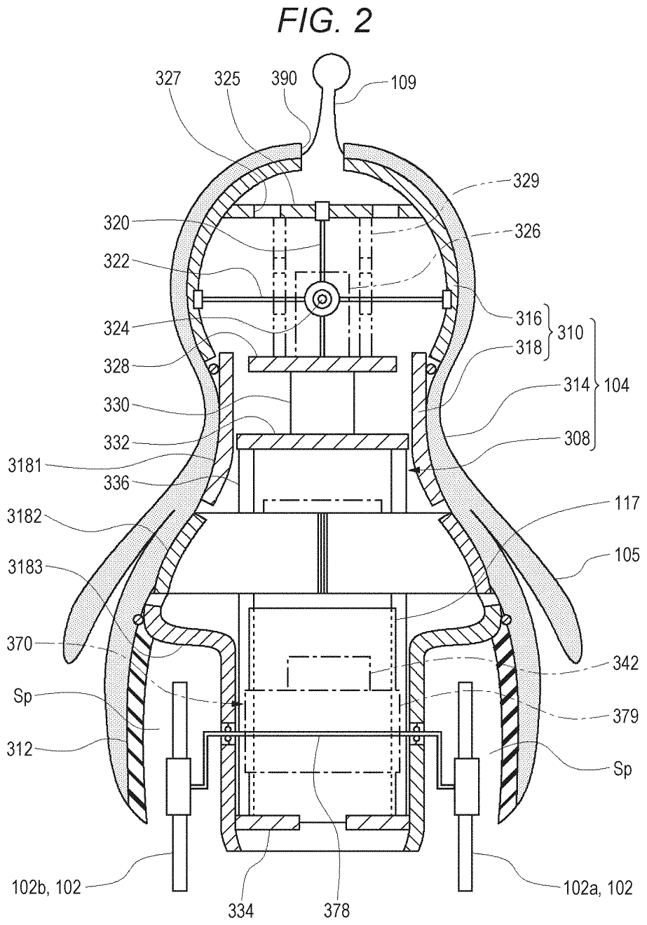

FIG. 2 is a sectional view schematically showing a Structure of the robot 100. As shown in FIG. 2, the body 104 of the robot 100 includes a base frame 308, a main body frame 310, a pair of resin wheel covers 312, and an outer skin 314. The base frame 308 is made of metal, configures an axial center of the body 104, and supports an internal structure. The base frame 308 is configured by an upper plate 332 and a lower plate 334 being linked vertically by a multiple of side plates 336. An interval sufficient for ventilation to be carried out is provided between the multiple of side plates 336. A battery 117, a control circuit 342, and various kinds of actuators are housed inside the base frame 308.

The main body frame 310 is formed from a resin material, and includes a head portion frame 316 and a trunk, portion frame 318. The head portion frame 316 is of a hollow hemispherical form, and forms a head portion framework of the robot 100. The trunk portion frame 318 is formed of a neck portion frame 3181, a chest portion frame 3182, and an abdominal portion frame 3183, is of a stepped cylindrical form overall, and forms a trunk portion framework of the robot 100. The trunk portion frame 318 is fixed integrally to the base frame 308. The head portion frame 316 is attached to an upper end portion (the neck portion frame 3181) of the trunk portion frame 318 in such a way as to be relatively displaceable.

Three shafts, those being a yaw shaft 320, a pitch shaft 322, and a roll shaft 324, and an actuator 326 for driving each shaft so as to rotate, are provided in the head portion frame 316. The actuator 326 includes a multiple of servo motors for driving each shaft individually. The yaw shaft 320 is driven for a head shaking action, the pitch shaft 322 is driven for a nodding action, and the roll shaft 324 is driven for a head tilting action.

A plate 325 for supporting the yaw shaft 320 is fixed to an upper portion of the head portion frame 316. A multiple of ventilation holes 327 for securing ventilation between portions above and below are formed in the plate 325.

A metal base plate 328 is provided in such a way as to support the head portion frame 316 and an internal mechanism thereof from below. The base plate 328 is linked to the plate 325 via a cross-link 329 (a pantograph mechanism), and is linked to the upper plate 332 (the base frame 308) via a joint 330.

The trunk portion frame 316 houses the base frame 308 and a wheel drive mechanism 370. The wheel drive mechanism 370 includes a rotary shaft 378 and an actuator 379. A lower half portion (the abdominal portion frame 3183) of the trunk portion frame 318 is of a small width in order to forma housing space Sp of the front wheel 102 between the trunk portion frame 318 and the wheel cover 312.

The outer skin 314 covers the main body frame 310 and the pair of arms 105 from an outer side. The outer skin 314 has a thickness of an extent such that a person feels elasticity. has a material that is soft and has elasticity, such as urethane sponge, as a base material, and is formed by being enclosed in a cloth material of a smooth texture, such as polyester. Because of this, a user feels an appropriate softness when hugging the robot 100, and can make natural bodily contact, as a person does with a pet. An aperture portion 390 for introducing external air is provided in an upper end portion of the outer skin 314.

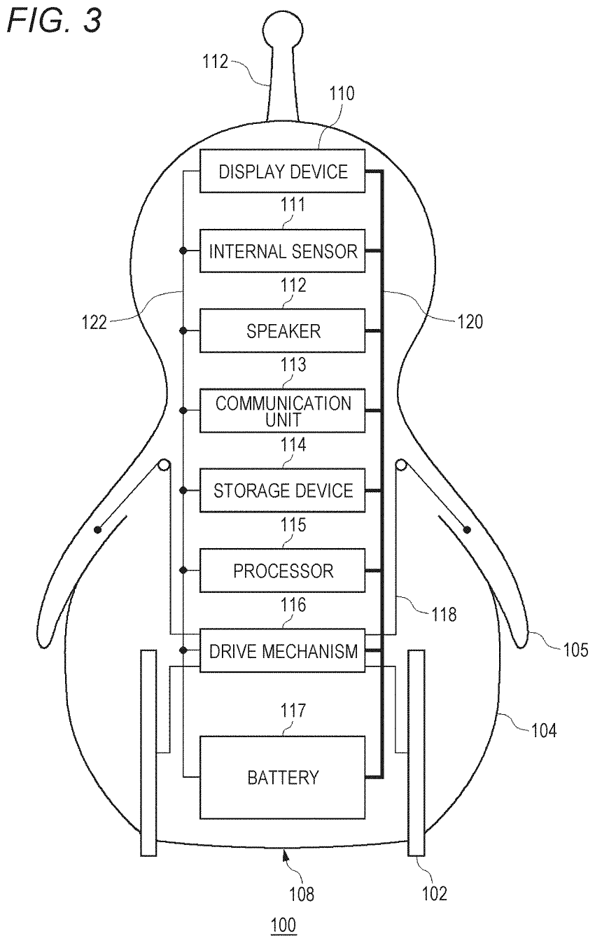

FIG. 3 is a drawing showing a hardware configuration of the robot 100. The robot 100 includes a display device 110, an internal sensor 111, a speaker 112, a communication unit 113, a storage device 114, a processor 115, a drive mechanism 116, and a battery 117 inside a frame 101. The drive mechanism 116 includes the heretofore described wheel drive mechanism 370. The processor 115 and the storage device 114 are included in the control circuit 342.

The units are connected to each other by a power line 120 and a signal line 122. The battery 117 supplies power to each unit via the power line 120. Each unit transmits and receives a control signal via the signal line 122. The battery 117 is, for example, a lithium ion rechargeable battery, and is a power source of the robot 100.

The drive mechanism 116 is an actuator that controls the internal mechanism. The drive mechanism 116 has a function of causing the robot 100 to move and of changing an orientation by driving the front wheels 102 and the rear -wheel 103. Also, the drive mechanism 116 controls the arm 105 via a wire 118, thereby causing actions such as raising the arm 105, waving the arm 10b, and driving the arm 105 to be carried out. Also, the drive mechanism 116 has a function of controlling the head portion, thereby changing an orientation of the head portion.

The internal sensor 111 is a collection of various kinds of sensors incorporated in the robot 100. As the internal sensor 111, there is, for example, a camera (omnidirectional camera), a microphone, a distance sensor (infrared sensor), a thermosensor, a touch sensor, an acceleration sensor, a smell sensor, and the like. The speaker 112 outputs speech.

The communication unit 113 is a communication module that carries out. wireless communication with a server, an external sensor, another robot, and various kinds of external devices, such as a mobile device possessed by a user, as a target. The storage device 114 is configured of a non-volatile memory and a volatile memory, and stores various kinds of programs, including a speech synthesizing program to be described hereafter, and various kinds of setting information.

The display device 110 is installed in a position of an eye of the robot 100, and has a function of causing an image of an eye to be displayed. The display device 110 displays an image of an eye of the robot 100 by combining eye parts such as a pupil and an eyelid. When external light or the like enters the eye, a catch light may be displayed in a position that is in accordance with a position of an external light source.

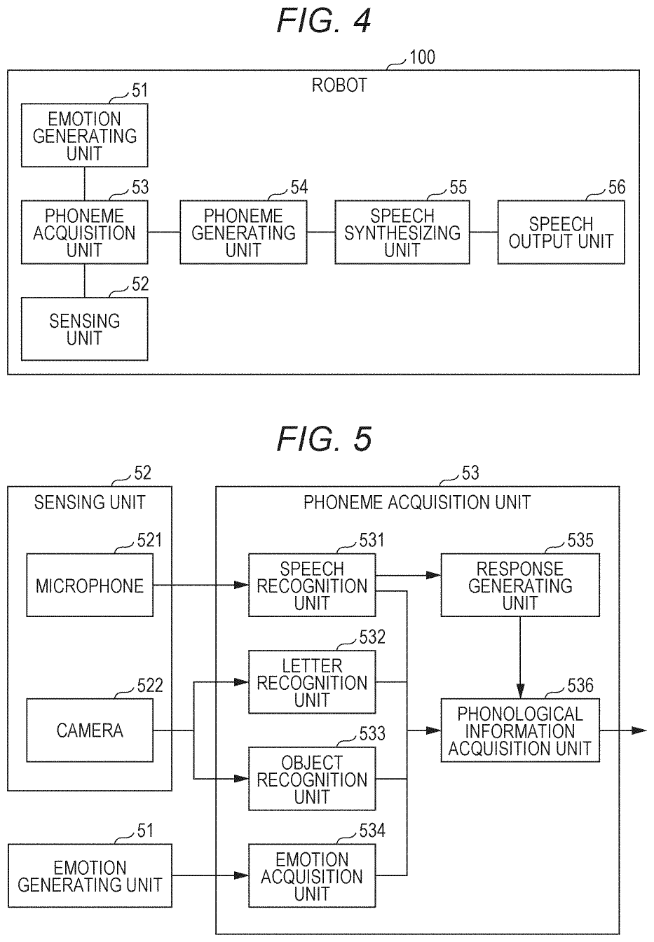

FIG. 4 is a block diagram showing a configuration of the robot 100 for outputting speech. The robot 100 includes an emotion generating unit 51, a sensing unit 52, a phoneme acquisition unit 53, a phoneme generating unit 54, a speech synthesizing unit 55, and a speech output unit 56. The emotion generating unit 51, the phoneme acquisition unit 53, the phoneme generating unit 54, and the speech synthesizing unit 55 are realized by a computer executing a speech synthesizing program of the embodiment.

The emotion generating unit 51 fixes an emotion of the robot 100. Emotions of the robot 100 are expressed by a multiple of emotion parameters. The emotion generating unit 51 fixes an emotion of the robot 100, in accordance with a predetermined rule, in accordance with an external environment or an internal parameter sensed by the sensing unit 52.

The sensing unit 52 corresponds to the heretofore described internal sensor 111, and includes a camera (omnidirectional camera), a microphone, a distance sensor (infrared sensor), a thermosensor, a touch sensor, an acceleration sensor, a smell sensor, and the like. The sensing unit 52 generates an input, signal by sensing an external environment of the robot 100.

The phoneme acquisition unit 53 acquires phonological information based on an emotion parameter input from the emotion generating unit 51 or an input signal input from the sensing unit 52. Although phonological information is generally information relating to a phonological sequence formed of a multiple of phonemes arranged in order, there are also cases wherein phonological information is formed of one phoneme (one syllable). For example, a phoneme can be represented by a kana character in Japanese, can be represented by a phonetic symbol in English, and can be represented by pinyin in Chinese. A method whereby the phoneme acquisition unit 53 acquires phonological information will be described in detail hereafter.

The phoneme generating unit 54 generates phonological information differing from phonological information acquired by the phoneme acquisition unit 53 based on at least one portion of phonemes in the phonological information acquired by the phoneme acquisition unit 53. Hereafter, phonological information acquired by the phoneme acquisition unit 53 will be called “first phonological information”, and phonological information generated by the phoneme generating unit 54 will be called “second phonological information”. Second phonological information differs from first phonological information, but is generated based on at least one portion of phonemes in the first phonological information. In the embodiment, the phoneme generating unit 54 generates two-syllable phonological information as second phonological information, even when first phonological information input from the phoneme acquisition unit 53 is of three syllables or more. Typically, when first phonological information is formed of, for example, three syllables, the phoneme generating unit 54 deletes one of the three syllables, and adopts only the remaining two syllables as second phonological information. A method whereby the phoneme generating unit 54 generates second phonological information will be described in detail hereafter.

The speech synthesizing unit 55 synthesizes speech in accordance with second phonological information generated by the phoneme generating unit 54. The speech synthesizing unit 55 can be configured of a synthesizer. Parameters for carrying out speech synthesis corresponding to each phoneme are stored in the speech synthesizing unit 5b, and when second phonological information is provided, the speech synthesizing unit 55 fixes a parameter for outputting the relevant phoneme as speech, and synthesizes speech. Speech synthesis by the speech synthesizing unit 55 will be described in detail hereafter.

The speech output unit 56 corresponds to the heretofore described speaker 112, and outputs speech synthesized by the speech synthesizing unit 55.

As heretofore described, the robot 100 of the embodiment includes the speech synthesizing unit 55, which synthesizes speech, because of which arbitrary speech can be synthesized and output. This means that rather than only being able to output fixed speech, as in a case wherein a speech file prepared in advance is reproduced, speech output that is in accordance with second phonological information generated based on first phonological information can be carried out. Because of this, a user can feel a likeness to a living being from the speech of the robot 100.

Also, the robot 100 of the embodiment generates second phonological information based on at least one portion of phonemes in first phonological information, and synthesizes speech in accordance with the second phonological information, rather than carrying out speech synthesis using acquired first phonological information as it is. Herein, when first phonological information includes linguistic information, second phonological information is generated using one portion of phonemes in the first phonological information, whereby the amount of linguistic information included in the first phonological information decreases.

Because of this, speech wherein a change has been made to one portion of phonemes can be synthesized, even when, for example, speech recognized using speech recognition is imitated and output as speech. Because of this, an imperfect mimicking (speech imitation) can be realized, and cuteness of the robot increases. Also, when a conversation is conducted between robots, speech of the other robot is recognized, and speech of a phonological sequence differing from that of the recognized speech can be synthesized, while utilizing at least one portion of phonemes of the recognized speech. The conversation (which is not a repetition of the same speech) can be continued by the two robots conducting the conversation executing the process. In the specification, linguistic information included in phonological information formed of a multiple of phonemes (a phonological sequence) means language represented by the phonological sequence, and a phonological sequence that does nor. represent a specific meaning, such as onomatopoeia, is understood to include no linguistic information, or to include an extremely small amount, of linguistic information.

Next, an acquisition of first phonological information by the phoneme acquisition unit 53 will be described in detail. FIG. 5 is a block diagram showing in detail configurations of the emotion generating unit 51, the sensing unit 52, and the phoneme acquisition unit 53 from the configuration of the robot 100 shown in FIG. 4. In the example of FIG. 5, the sensing unit 52 includes a microphone 521 and a camera 522. The phoneme acquisition unit 53 includes a speech recognition unit 531, a letter recognition unit 532, an object recognition unit 533, an emotion acquisition unit 534, a response generating unit 535, and a phonological information acquisition unit 536.

As heretofore described, the emotion generating unit 51 fixes an emotion of the robot 100, in accordance with a predetermined rule, in accordance with an external environment or an internal parameter sensed by the sensing unit 52, and outputs an emotion parameter to the phoneme acquisition unit 53. The microphone 521 senses a sound forming an external environment, generates a speech signal as an input signal, and outputs the speech signal to the phoneme acquisition unit 53. The camera 522 senses an incident light forming an external environment, generates an image signal as an input signal, and outputs the image signal to the phoneme acquisition unit 53.

The speech recognition unit 531 carries out speech recognition with respect to a speech signal obtained by a sound being sensed by the microphone 521, thereby acquiring a letter sequence. The speech recognition unit 531 outputs the letter sequence obtained using speech recognition to the response generating unit 535 and the phonological information acquisition unit 536. An existing arbitrary speech recognition engine can be used for the speech recognition. A common speech recognition engine is such that after a phonological sequence is recognized from an input speech signal, a letter sequence including linguistic information is obtained by implementing a natural language processing such as a morphological analysis with respect to the phonological sequence. In the embodiment, a letter sequence wherein linguistic information is obtained by a natural language processing is output to the response generating unit 535 and the phonological information acquisition unit 536. The letter sequence includes phonological information (that is, a phonological sequence) of the letter sequence and linguistic information (that is, information obtained by a natural language processing).

The response generating unit 535 generates a response to speech recognized by the speech recognition unit 531, and outputs a letter sequence of the response to the phonological information acquisition unit 536. An existing arbitrary dialog engine can be used in generating the response. The dialog engine may generate a response to recognized speech using a machine learning model wherein a response to an input letter sequence has been learned.

The letter recognition unit 532 acquires a letter sequence by carrying out letter recognition with respect, to an image signal obtained by a periphery of the robot 100 being filmed by the camera 522, and outputs the letter sequence to the phonological information acquisition unit 536. An existing arbitrary letter recognition engine can be used for the letter recognition. The letter recognition engine can carry out letter recognition using a machine learning model such as a neural network. The letter recognition engine may be a letter recognition engine that recognizes each letter of a letter sequence independently from an input image signal. Also, the letter recognition engine may be a letter recognition engine that recognizes a letter sequence from an input image signal, and subsequently obtains a letter sequence including linguistic information by implementing a natural language processing with respect to the letter sequence.

The object recognition unit 533 carries out object recognition with respect to an image signal obtained by a periphery of the robot 100 being filmed by the camera 522. An existing arbitrary object recognition engine can be used for the object recognition. The object recognition engine recognizes an object in an image, and allocates a label indicating a name of the object. A machine learning model such as a neural network can also be employed as the object recognition engine. Human recognition whereby a face of a person in an image is recognized, and a user identified, is also included in the object recognition. In the case of human recognition, a user name is obtained as a label as a result of recognizing a face. The object recognition unit 533 outputs a letter sequence of a label obtained by recognition to the phonological information acquisition unit 536.

The emotion acquisition unit 534 acquires an emotion parameter from the emotion generating unit 51, and ascertains the two syllables of phoneme closest to the acquired emotion parameter by referring to a phoneme-emotion table.

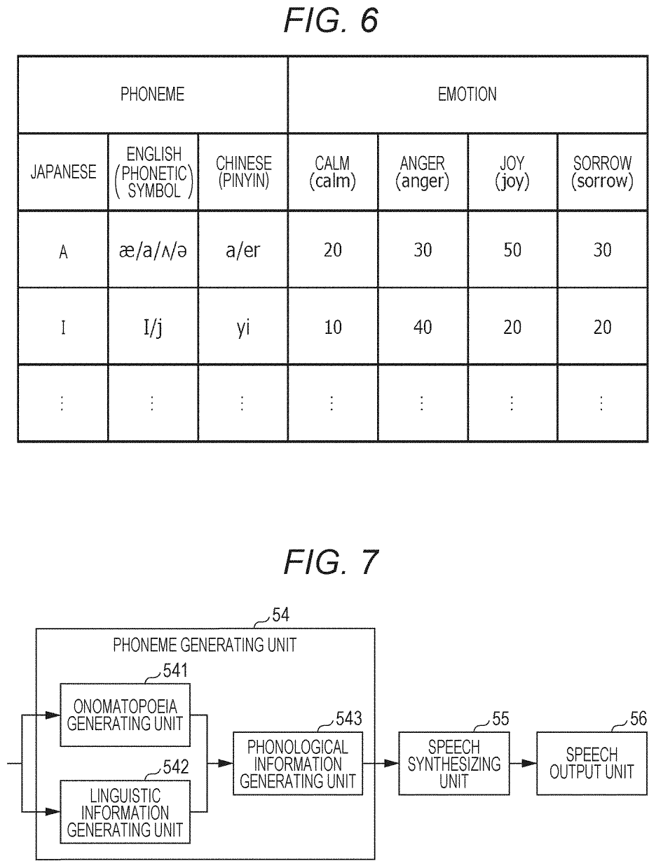

FIG. 6 is an example of a phoneme-emotion table that stipulates a relationship between a phoneme and an emotion parameter. As shown in FIG. 6, four kinds of emotion parameters, which are “calm”, “anger”, “joy”, and “sorrow”, are defined for each phoneme. Each emotion parameter has a value of between 0 and 100.

The emotion acquisition unit 534 selects the two syllables of phoneme having the emotion parameters whose total difference with each acquired emotion parameter is smallest from the phoneme-emotion table, thereby ascertaining the two syllables of phoneme closest to the acquired emotion parameter A method of ascertaining a phoneme based on an emotion parameter not being limited to this, the emotion acquisition unit 534 may, for example, select the phoneme wherein the total difference between one portion of emotion parameters (for example, two) having the greatest values among acquired emotion parameters is smallest.

The phonological information acquisition unit 536 acquires a letter sequence input from each of the speech recognition unit 531, the response generating unit 535, the letter recognition unit 532, and the object recognition unit 533, and converts the letter sequences into first phonological information. In the case of Japanese, the phonological information acquisition unit 536 acquires a letter sequence in which Chinese characters are included, or a letter sequence of only kana, as a letter sequence. In the case of English, the phonological information acquisition unit 536 acquires a letter sequence formed of one or a multiple of words expressed using the alphabet. In the case of Chinese, the phonological information acquisition unit 536 acquires a letter sequence formed of a multiple of Chinese characters. Also, when acquiring a phonological sequence from the emotion acquisition unit 534, the phonological information acquisition unit 536 adopts the phonological sequence as first phonological information.

Herein, phonological information is formed of phonemes that are unit sounds in speech in the relevant language. As heretofore described, phonological information may be expressed by kana in the case of Japanese. Phonological information may be expressed by phonetic symbols in the case of English. Phonological information may be expressed by pinyin in the case of Chinese. In the case of Japanese, the phonological information acquisition unit 536 refers to a dictionary that stipulates a relationship between a Chinese character and a kana reading thereof when there is a Chinese character in a letter sequence, converts the Chinese character into kana, and aligns all the kana, thereby acquiring first phonological information. In the case of English, the phonological information acquisition unit 536 refers to a dictionary that stipulates a relationship between a word and a phonetic symbol, and replaces each word in a letter sequence with a phonetic symbol, thereby acquiring first phonological information. In the case of Chinese, the phonological information acquisition unit 536 refers to a dictionary that stipulates a relationship between each Chinese character and pinyin, and replaces a Chinese character with pinyin, thereby acquiring first phonological information. The phonological information acquisition unit 536 outputs acquired first phonological information to the phoneme generating unit 54.

FIG. 7 is a block diagram showing in detail configurations of the phoneme generating unit 54, the speech synthesizing unit 55, and the speech output unit 56 from the configuration of the robot 100 shown in FIG. 4. The phoneme generating unit 54 includes an onomatopoeia generating unit 541, a linguistic information generating unit 542, and a phonological information generating unit 543. The onomatopoeia generating unit 541 identifies an emotion parameter corresponding to at least one portion of phonemes in first phonological information by referring to the phoneme-emotion table. The onomatopoeia generating unit 541 fixes a phoneme based on the identified emotion parameter, and outputs the fixed phoneme to the phonological information generating unit 543. Specifically, the onomatopoeia generating unit 541 of the embodiment fixes a phoneme including an emotion parameter close to an emotion parameter of a phoneme in first phonological information.

Specifically, when first phonological information includes a one-syllable phoneme, the onomatopoeia generating unit 541 refers to the phoneme-emotion table, and identifies the emotion having the greatest value among emotion parameters of the phoneme. Further, the onomatopoeia generating unit 541 fixes two other phonemes wherein the emotion parameter of the emotion is of the same value. For example, when first phonological information is only the one syllable “a”, the onomatopoeia generating unit 541 refers to the four kinds of emotion parameters of the syllable “a” in the table. Of the four kinds of emotion parameters of “a”, it is the “joy” parameter that has the greatest value, with the value thereof being 50. Therefore, the onomatopoeia generating unit 541 searches for other phonemes whose “joy” parameter is 50, and fixes, for example, the phonemes “ru” and “ni”.

When first phonological information includes two syllables of phoneme, the onomatopoeia generating unit 541 performs the same procedure as that described above for each phoneme, thereby fixing two syllables of phoneme corresponding to the two syllables of phoneme in the first phonological information. When first phonological information is of three or more syllables, the onomatopoeia generating unit 541 selects two syllables of phoneme from the three or more syllables of phoneme, arbitrarily or based on a predetermined rule. Further, the onomatopoeia generating unit 541 performs the same procedure as that described above for each selected phoneme, thereby fixing two corresponding syllables of phoneme The number of syllables may be a predetermined number of syllables or less instead of two syllables.

The linguistic information generating unit 542 generates a letter sequence having an amount of linguistic information smaller than that of input first phonological information, and outputs the letter sequence to the phonological information generating unit 543. The linguistic information generating unit 542 reduces the amount of linguistic information by carrying out a partial deletion of, a partial change to, or a partial addition to a letter or a phoneme with respect to a letter sequence of the first phonological information. Which of a partial deletion, a partial change, or a partial addition is to be carried out, and which letter or phoneme is to be deleted, changed, or added to, may be determined arbitrarily or based on a predetermined rule.

When, for example, first phonological information “clock” is input, the linguistic information generating unit 542 may generate a letter sequence “clo'”, wherein one portion of “clock” has been deleted. When first phonological information “satsuma” is input, the linguistic information generating unit 542 may generate a letter sequence “tatsuma”, wherein one portion of consonants of “satsuma” has been replaced. When first phonological information “good morning” is input, the linguistic information generating unit 542 may generate a letter sequence “'ood morning”, wherein one portion of consonants of “good morning” has been deleted. When first phonological information “clock” is input, the linguistic information generating unit 542 may generate a letter sequence “clocky”, wherein an extra sound has been added to “clock”. When first phonological information “cuddle” is input, the linguistic information generating unit 542 may generate a letter sequence “cu'le”, wherein the double consonant sound has been deleted from “cuddle”. It can be said that the amount of linguistic information in the letter sequences “clo'”, “tatsuma”, “'ood morning”, “clocky”, and “cu'le” generated by the linguistic information generating unit 542 has decreased due to the point that the letter strings resemble “clock”, “satsuma”, “good morning”, “clock”, and “cuddle” respectively, but do not coincide completely. The linguistic information generating unit 542 may further reduce linguistic information by using a combination of a partial deletion of, a partial change to, or a partial addition to a letter or phoneme, and a change in phoneme order. A partial change to a letter or a phoneme may be a change to a similar phoneme in another language.

Methods of reducing the amount of linguistic information are not limited to those described above. Changes such as reducing the number of phonemes, eliminating linguistic meaning, rendering a word incomplete, or rendering one portion of phonemes difficult to catch, all reduce the amount of linguistic information. Also, kinds of phoneme that can be used may be limited, and second phonological information may be generated by replacing each phoneme included in first phonological information with a phoneme from among the limited phonemes. Also, second phonological information may be generated by deleting phonemes other than phonemes that can be used from among phonemes included in first phonological information.

By generating second phonological information by reducing the amount of linguistic information in first phonological information including linguistic information in this way, second phonological information that resembles the linguistic information of the first phonological information is generated. This means that by the robot 100 synthesizing and outputting speech in accordance with this kind of second phonological information, a user can deduce, or wishes to deduce, what the robot 100 wishes to say. That is, it is by the robot 100 uttering childish words that a user is caused to think that “it seems like the robot wants to say something, it -wants to tell me something”. By extension, it is conceivable that the user can be subconsciously led to understand the robot 100, to have curiosity about the robot 100, or to focus on the robot 100. Because of this, a psychological effect wherein the user is not caused to become bored, and in time is led to feel affection toward the robot 100, can be expected.

In a provisional case wherein the robot 100 synthesizes and outputs speech using first phonological information including linguistic information as it is, for example, a case wherein the robot 100 clearly pronounces “clock”, a user simply recognizes that the robot 100 is saying “clock”, and pays no attention to the robot 100 beyond that. As opposed to this, when the robot 100 reduces the amount of linguistic information, and pronounces the word as the linguistically imperfect “clo'”, the user may become aware of the robot 100, thinking that the robot 100 is attempting to say “clock”. By extension, when the user feels cuteness in the imperfection, a formation of affection from the user toward the robot 100 may be promoted.

Heretofore, in order to describe a generation by the linguistic information generating unit 642 of a letter sequence wherein the amount of linguistic information has been reduced, an example wherein two to four syllables of letter are generated has been described. As heretofore described, the phoneme generating unit 54 generates second phonological information including two syllables of phoneme. The linguistic information generating unit 542 arranges in such a way that generated second phonological information is of two syllables by carrying out a partial deletion of or a partial addition to a letter or a phoneme. Second phonological information of a predetermined number of syllables or less can be generated using the same kind of process.

By the onomatopoeia generating unit 541 fixing a syllable in the way heretofore described, second phonological information including a phoneme of an emotion resembling an emotion represented by a phoneme of first phonological information can be generated. Also, linguistic information is not taken into consideration when generating second phonological information in this case, because of which second phonological information formed of a meaningless two syllables of phoneme is generated.

Also, the linguistic information generating unit 542 generates a letter sequence wherein the amount of linguistic information in first phonological information has been reduced in the way heretofore described, because of which second phonological information wherein the first phonological information is imperfectly expressed can be generated.

The phonological information generating unit 543 generates phonological information relating to a phonological sequence fixed by the onomatopoeia generating unit 541, or generates phonological information relating to a letter sequence generated by the linguistic information generating unit 542, and outputs the phonological information as second phonological information to the speech synthesizing unit 55.

The speech synthesizing unit 55 synthesizes speech based also on information other than phonological information. For example, a meter (stress, length, pitch, and the like) of speech to be synthesized may be determined based on information other than second phonological information. Specifically, the speech synthesizing unit 55 stores four kinds of metrical curves as metrical patterns, and fixes a meter of each syllable by allotting one metrical pattern to each syllable of speech to be synthesized.

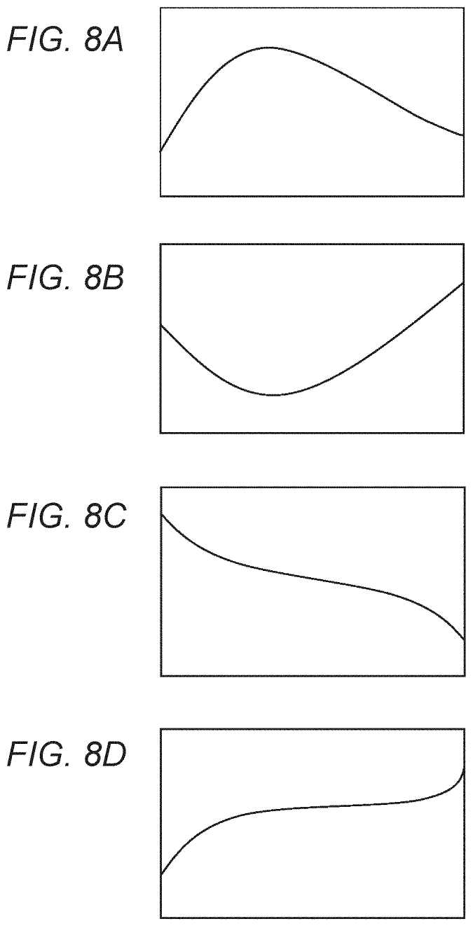

FIGS. 8A to 8D are drawings showing four kinds of metrical curves. The speech synthesizing unit 55 fixes the meter of each syllable by allotting one of the metrical curves to each syllable. The speech synthesizing unit 55 selects the metrical curve to be allotted in accordance with a phoneme (pronunciation) of a syllable. The metrical curve to be allotted to each phoneme is decided in advance, and stored in the speech synthesizing unit 55 as a phoneme-metrical curve table. A metrical curve of FIG. 8A is an example of a metrical curve allotted to the phoneme “a”. A metrical curve of FIG. 8B is an example of a metrical curve allotted to the phoneme “i”. The speech synthesizing unit 55 fixes the meter of each syllable by referring to the phoneme-metrical curve table.

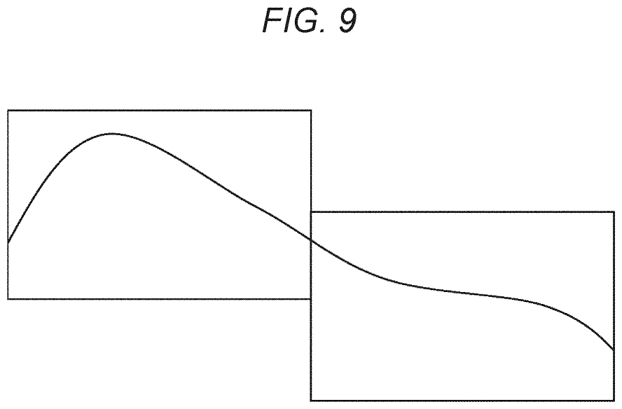

FIG. 9 is a drawing showing a meter of two syllables. When the speech synthesizing unit 55 fixes the meter of two consecutive syllables using metrical curves, the speech synthesizing unit 55 causes the metrical curves of the two consecutive syllables to be linked smoothly, as shown in FIG. 9. In the example of FIG. 9, the metrical curve of FIG. 8A and a metrical curve of FIG. 8C are linked.

The speech synthesizing unit 55 has virtual vocal organs. In general, voice emitting processes of living beings having vocal organs are the same. For example, a human voice emitting process is such that a sound is formed by air led from the lungs or the abdomen via the trachea vibrating in the vocal cords, and becomes a larger sound by resonating in the oral cavity, the nasal cavity, or the like. Further, various voices arise owing to the shape of the mouth or the tongue changing. Individual differences between voices arise owing to various differences, such as differences in body size, lung capacity, vocal cord or trachea length, oral cavity size, nasal cavity size, tooth alignment, and how the tongue is moved. Also, even in a case of the same person, a condition of the trachea, the vocal cords, or the like changes in accordance with physical condition, and the voice changes. Because of this kind of voice emitting process, voice quality varies by person, and a voice also changes in accordance with an internal state such as physical condition or emotion.

Based on this kind of voice emitting process, the speech synthesizing unit 55 in another embodiment generates speech by simulating a voice emitting process in virtual vocal organs. That is, the speech synthesizing unit 55 is virtual vocal organs (hereafter called “virtual vocal organs”), and generates a voice using virtual vocal organs realized by software. For example, the virtual vocal organs may be of a structure that imitates human vocal organs, or may be of a structure that imitates the vocal organs of an animal such as a dog or a cat. By having virtual vocal organs, speech unique to an individual can be generated, even though a basic vocal organ structure is the same, by changing the size of the trachea in the virtual vocal organs, adjusting the tension of the vocal cords, or changing the size of the oral cavity for each individual. Parameters for generating speech include not simply direct parameters for generating a sound using a synthesizer, but also include values that specify structural characteristics of each of the virtual vocal organs as parameters (hereafter called “static parameters”) . Using these static parameters, a voice emitting process is simulated, and a voice is generated.

For example, a human can emit various kinds of voices. A human can emit any kind of voice, including a high voice, a low voice, singing in accordance with a melody, laughing, and shouting, as far as the vocal organ structure permits. This is because a form and a state of each organ configuring the vocal organs changes, and while a human can change the voice consciously, the voice also changes subconsciously in accordance with an emotion or a stimulus. The speech synthesizing unit 55 also has parameters relating to a state of these organs that change in conjunction with an external environment or an internal state (hereafter called “dynamic parameters”), and carries out a simulation causing the dynamic parameters to change in conjunction with an external environment or an internal state.

In general, when the vocal cords are tautened, the vocal cords lengthen, and a high sound is formed, and when the vocal cords are relaxed, the vocal cords contract, and a low sound is formed. For example, an organ resembling a vocal cord has a degree of vocal cord tautening (hereafter called “tautness”) as a static parameter, and a high voice or a low voice can be emitted by the tautness being adjusted. Because of this, the high-voiced robot 100 and the low-voiced robot 100 can be realized. Also, a voice sometimes cracks due to a person being tense, and in the same way, by causing the vocal cord tautness acting as a dynamic parameter to change in conjunction with a state of tenseness of the robot 100, the voice can become high when the robot 100 is tense. For example, when an internal parameter indicating a state of tenseness swings toward a value indicating that the robot 100 is tense, such as when the robot 100 recognizes an unknown person or when the robot 100 is suddenly lowered from a state of being hugged, the tautness of the vocal cords is increased in conjunction therewith, whereby a high voice can be emitted. By an internal state of the robot 100 and an organ of the speech emitting process being correlated in this way, and a parameter of the correlated organ being adjusted in accordance with the internal state, the voice can be changed in accordance with the internal state.

Herein, a static parameter and a dynamic parameter are parameters that indicate a geometric state of each organ accompanying an elapse of time. The virtual vocal organs carry out a simulation based on these parameters.

Also, by speech being generated based on a simulation, only speech based on a structural limitation of the vocal organs is generated. That is, no voice infeasible as that of a living being is generated, because of which a voice like that of a living being can be generated. By carrying out a simulation and generating speech, a voice affected by the internal state of the robot 100 can be generated, rather than a similar syllable simply being vocalized.

The robot 100 constantly causes the sensor group including the microphone 521 and the camera 522 to operate, and also constantly causes the emotion generating unit 51 to operate. By a user talking to the robot 100 in this kind of state, the microphone 521 of the robot 100 senses the sound, and outputs a speech signal to the phoneme acquisition unit 53, whereby the heretofore described process is started. Also, the camera 522 films the face of the user, and outputs an image signal to the phoneme acquisition unit 53, whereby the heretofore described process is started. Also, the emotion generating unit 51 generates an emotion parameter based on an external environment or an internal parameter, and outputs the emotion parameter to the phoneme acquisition unit 53, whereby the heretofore described process is started. Not all results of an external environment detection by the sensing unit 52 form a trigger for generating speech, and whether or not speech is to be generated is decided in accordance with the internal state of the robot 100 at the time.

In the embodiment, the phoneme acquisition unit 53 is such that a letter sequence including linguistic information is input into the phonological information acquisition unit 536 from the speech recognition unit 531, but instead of this, a phonological sequence recognized by the phoneme recognition unit 531 may be input as it is into the phonological information acquisition unit 536, and the phonological information acquisition unit 536 may adopt the input phonological sequence as it is as first phonological information. That is, a natural language processing by the speech recognition unit 531 need not be carried out.

In the embodiment, a configuration wherein the sensing unit 52 includes the microphone 521 and the camera 522 has been described as an example, but when, for example, a thermosensor is used as the sensing unit 52, the sensing unit 52 may detect a temperature, and the phoneme acquisition unit 53 may acquire first, phonological information such as “it's cold” or “it's hot” in accordance with the detected temperature, and when a smell sensor is used as the sensing unit 52, the sensing unit 52 may detect a smell, and the phoneme acquisition unit 53 may acquire first phonological information such as “it stinks” in accordance with the detected smell.

Also, in the embodiment, the onomatopoeia generating unit 541 fixes other phonemes whose largest emotion parameter among emotion parameters corresponding to a phoneme in first, phonological information are the same as phonemes whose emotion parameters are close, but a method of fixing other phonemes is not limited to this. For example, phonemes having a multiple of emotion parameters whose differences from each of a multiple of emotion parameters corresponding to a phoneme in first phonological information are small (for example, a total difference is small) may be fixed as phonemes whose emotion parameters are close. Also, the onomatopoeia generating unit 541 may fix a phoneme whose emotion parameter differs largely from an emotion parameter corresponding to a phoneme in first phonological information. For example, a phoneme whose emotion parameter “sorrow” is strong may be fixed in response to a phoneme whose emotion parameter “anger” is strong.

According to the robot 100 of the embodiment, for example, the following kind of performance can be carried out. That is, the robot 100 of the embodiment is such that when the phoneme acquisition unit 53 acquires first phonological information including three syllables of phoneme using speech recognition, letter recognition, object recognition, or the like, the phoneme generating unit 54 deletes one of the three syllables, and generates second phonological information formed of two syllables of phoneme. Because of this, the robot 100 mimics and outputs heard speech using a small number of syllables, and a performance that seems as though an infant with little speech capability is imperfectly mimicking and outputting heard speech can be carried out.

Also, the robot 100 of the embodiment is such that when the phoneme acquisition unit 53 acquires first phonological information by recognizing two syllables of speech output from another robot, the phoneme generating unit 54 fixes a phoneme having an emotion parameter close to, or far from, an emotion parameter corresponding to the two syllables of phoneme, and generates second phonological information. Therefore, by two of this kind of robot 100 conducting a conversation, a performance that seems as though the robots 100 are conducting a conversation while being affected by an emotion of the other can be carried out.

Hereafter, various modifications of the robot 100 described above will be described. The phoneme acquisition unit 53 may recognize a pitch of a speech signal input from the microphone 521, and the speech synthesizing unit 55 may synthesize speech having a pitch the same as the pitch of the input speech signal. For example, when a speech signal of 440 Hz is input from the microphone 521, the speech synthesizing unit 55 may synthesize speech of the same 440 Hz. Also, the speech synthesizing unit 55 may synthesize speech wherein the pitch of an input speech signal is adjusted to a predetermined scale. For example, when speech of 433 Hz is input from the microphone 521, the speech synthesizing unit 55 may synthesize speech of 440 Hz.

Also, the phoneme acquisition unit 53 may recognize a pitch change of speech input from the microphone 521, and the speech synthesizing unit 55 may synthesize speech having a pitch change the same as the pitch change of the input speech signal. Because of this, a performance that seems as though the robot 100 is vocalizing by mimicking a melody of a heard sound can be carried out.

Also, the sensing unit 52 may include a torque sensor of the front wheel 102, and the speech synthesizing unit 55 may generate speech in accordance with a value of the torque sensor. For example, when the robot 100 is unable to proceed in a direction of travel due to an obstacle, and front wheel torque increases, the speech synthesizing unit 55 may synthesize speech indicating exertion, such as “oof”.

Also, when a human face is suddenly recognized at a predetermined size in an image during human recognition by the object recognition unit 533, the speech synthesizing unit 55 may synthesize laughing speech. Alternatively, when a human face is suddenly recognized at a predetermined size in an image, the emotion generating unit 51 may generate the emotion parameter “joy”, output the emotion parameter to the phoneme acquisition unit 53, and synthesize speech by carrying out a process of generating first phonological information and second phonological information using the heretofore described process.

Also, in the embodiment, the phoneme acquisition unit 53 acquires first phonological information that expresses a letter or an object recognized from an image filmed by the camera 522, but when an object is recognized from an image, the phoneme acquisition unit 53 may acquire first phonological information by generating a letter sequence for speaking to the object. For example, when an object, is recognized using object recognition, the phoneme acquisition unit 53 may acquire the first phonological information “cuddle”, which is asking for a cuddle. Also, when an object, is recognized from an image, the phoneme acquisition unit 53 may acquire first phonological information by generating a letter sequence of a correlated word correlated to the object. For example, when an airplane is recognized using object recognition, the phoneme acquisition unit 53 may acquire the onomatopoeic first phonological information “whoosh” correlated to the airplane.

Also, when a demand is not met after outputting speech making a demand, the speech synthesizing unit 55 may synthesize speech wherein volume, a speaking speed, or the like differs. For example, when the robot 100 is not cuddled after synthesizing and outputting the speech “cuddle” as speech indicating a desire to be cuddled, the speech synthesizing unit 55 may generate the speech “cuddle!”, wherein the voice is raised.

Also, after speech is output from the speech output unit 56, the emotion generating unit 51 may generate the emotion “joy” when speech having a phoneme the same as that of the output speech is recognized by the speech recognition unit 531. Because of this, a performance that seems as though the robot 100 is happy when a user mimics what the robot 100 says can be carried out. Also, the robot 100 may detect a reaction of a user after speech is output from the speech output unit 56, and learn by allotting a score to the output speech. For example, when the object recognition unit 533 detects a smiling face from an image after speech is output, the robot 100 may learn by allotting a high score to the speech. The robot 100 may, for example, synthesize and output speech with a high score with priority.

Also, when the speech recognition unit 531 recognizes speech simultaneously with the object recognition unit 533 recognizing an object, the recognized object and the recognized speech are correlated and learned, after which the object is recognized. In this case, the phoneme acquisition unit 53 may acquire first phonological information relating to the correlated speech. For example, when the speech “cup” is recognized by the speech recognition unit 531 simultaneously with a cup being recognized by the object recognition unit 533, the combination is learned, and the phoneme acquisition unit 53 may acquire the first phonological information “cup” when the object recognition unit 533 subsequently recognizes a cup. Because of this, a performance such that a user can teach the robot 100 the name of an object, and the robot 100 learns the name of the object taught by the user, can be carried out.

Also, by learning being repeated, an amount of decrease in the amount of linguistic information between first phonological information and second phonological information may be reduced. For example, when acquiring the first phonological information “father” by learning, one portion of phonemes in the first phonological information is deleted, and second phonological information “erfa”, wherein “er” and “fa”, whose order is changed and which are not even neighboring, are arranged in order, is generated at first. Each time learning is repeated, the amount of decrease in the amount of linguistic information may be gradually reduced by, for example, generating second phonological information “fa'er” wherein, while one portion of phonemes is deleted, “fa” and “er”, whose order is not changed but. as before are not neighboring, are arranged in order, and finally adopting “fath”, wherein “fa” and “th” are neighboring in the correct order and are formed of characteristic sounds (for example, strongly stressed phonemes).

Also, the speech output unit 56 may adjust the volume of speech to be output in accordance with the volume of a sound sensed by the microphone 521. For example, when the volume of a sound sensed by the microphone 521 is high, the speech output unit 56 may increase the volume of speech to be output. Furthermore, the speech output unit 56 may adjust the volume of speech to be output in accordance with the volume of speech recognized to be noise by the speech recognition unit 531. That is, the speech output unit 56 may increase the volume of speech to be output in a noisy environment.

Also, in the embodiment, it has been described that the robot 100 can continue a conversation with another robot 100, but in order for robots 100 to conduct a conversation, each robot 100 may further have the following functions.

The emotion generating unit 51 may develop a story in a conversation between robots 100, and generate an emotion in keeping with the story. Further, the robot 100 outputs speech expressing an emotion using the heretofore described functions of the phoneme acquisition unit 53 or the speech output unit 56. A machine learning model such as a neural network may also be used in the story development by the emotion generating unit 51.

The speech synthesizing unit 55 may synthesize speech in accordance with speech of another robot 100 input from the microphone 521 in such a way that intervals harmonize. By so doing, a performance that seems as though a multiple of robots 100 are singing in chorus can be carried out. Also, a performance of singing out of tune can also be carried out by deliberately adopting an interval that differs from an interval of speech of the other robot 100.

Also, the speech synthesizing unit 55 may synthesize speech of a pitch that a normal human does not use. The pitch of speech of a normal human is in the region of approximately 500 Hz at highest, but the robot 100 outputs speech at a higher pitch (for example, in the region of approximately 800 Hz). Another robot 100 can recognize that speech is that of a separate robot 100 from pitch information only. For example, when the robot 100 is playing tag, the robot 100 needs to recognize a call from or a direction of an opponent, but provided that an input pitch is within a predetermined range, the robot 100 can recognize that speech (meaning “over here” or the like) is that of the opposition robot 100. Also, recognition accuracy can be increased by further combining a pattern (a pitch curve change or the like) with pitch. Also, when recognizing using pitch alone, there is also a possibility of picking up, for example, the sound of an ambulance siren, but conversely, unconditionally reacting to a high noise can also be utilized as an expression of animal-like behavior.

Also, the phoneme acquisition unit 53 acquires first phonological information based on an input signal from the sensing unit 52 or an emotion parameter from the emotion generating unit 51. The phoneme acquisition unit 53 may furthermore acquire information relating to volume, pitch, or tone, which is an element configuring a sound, based on an input signal or an emotion parameter, or based on other information. In this case, the phoneme generating unit 54 may fix the volume, the pitch, and the tone of speech to be synthesized by the speech synthesizing unit 55 based on the information relating to volume, pitch, and tone acquired by the phoneme acquisition unit 53, and output the volume, the pitch, and the tone to the speech synthesizing unit 55. Also, with regard to a length of each phoneme (a speech rate) too, a configuration may be such that the phoneme acquisition unit 53 acquires a speech rate, and the phoneme generating unit 54 fixes the rate of speech to be output by the speech output unit 56 based on the acquired speech rate. Furthermore, the phoneme acquisition unit 53 may also acquire a characteristic of each language as an element configuring a sound.

Also, the phoneme acquisition unit 53 may include a function of determining whether or not there is a tune (that is, whether or not an input sound is a song or a melody) based on a speech signal input from the microphone 521. In this case, the phoneme acquisition unit 53, specifically, allots a score in accordance with a change in pitch in each predetermined period, and determines whether or not there is a tune (that is, whether or not someone is singing) based on the score. When the phoneme acquisition unit 53 determines that there is a tune in an input speech signal, the speech synthesizing unit 55 may fix the length or pitch of each phoneme of speech to be synthesized in such a way as to imitate the recognized tune. Also, when the phoneme acquisition unit 53 determines that there is a tune in an input speech signal, the phoneme generating unit 54 generates second phonological information using a phoneme decided in advance. Further, the speech synthesizing unit 55 may fix the length or pitch of each phoneme of speech to be synthesized in such a way as to imitate the recognized tune. Because of this, a performance that seems as though the robot 100 is humming can be carried out.

Also, the phoneme acquisition unit 53 may acquire a letter sequence of a language other than Japanese based on an input signal from the sensing unit 52. That is, the speech recognition unit 531 may recognize speech in a language other than Japanese, and generate a letter sequence in the relevant language, the letter recognition unit 532 may recognize a letter in a language other than Japanese, and generate a letter sequence in the relevant language, and the object recognition unit 533 may recognize an object, and generate a letter sequence in a language other than Japanese representing the relevant object.

Also, when a mimicking response has been carried out a predetermined number of times (for example, five times), the robot 100 may repeat a previous predetermined number of mimickings (for example, four) consecutively. As heretofore described, the robot 100 outputs two syllables of speech, but as there is a possibility of a user becoming bored when only two syllables of mimicking are repeated, the robot 100 may link and emit speech mimicked and output in the past every predetermined number of times. Because of this, an advantage can he expected in that the user can feel that the robot 100 is attempting to say something.

Because of this, the robot 100 includes a storage unit in which second phonological information generated as mimicry is stored, a counting unit that counts a number of mimickings, and a determination unit, that determines whether or not the number of mimickings has reached a predetermined number (for example, five), and when it is determined by the determination unit that the number of mimickings has reached the predetermined number, the speech synthesizing unit 55 retrieves the mimickings stored in the storage unit, and synthesizes speech by linking the mimickings.

The invention is such that a formation of affection from a user toward a robot can be promoted during speech communication with another party carried out by the robot outputting speech, and is useful as a robot that outputs speech, or the like.

What is claimed is:

1. A robot, comprising:
a non-transitory computer readable medium configured to store instructions;
a speaker; and
a processor connected to the non-transitory computer readable medium, wherein the processor is configured to execute the instructions for:
acquiring first phonological information formed of a plurality of phonemes;
generating second phonological information differing from the first phonological information based on at least one portion a phoneme of the plurality of phonemes included in the first phonological information;
generating a speech signal in accordance with the second phonological information; and
instructing the speaker to output speech based on the generated speech signal.

2. The robot according to claim 1, wherein the processor is configured to generate the second phonological information including second linguistic information having a second amount of linguistic information , acquire first linguistic information of the first phonological information having a first amount of linguistic information, wherein the second amount of linguistic information is less than the first amount of linguistic information.

3. The robot according to claim 2, further comprising a sensor configured to detect an external environment and generate an input signal, wherein
the processor is configured to acquire the first phonological information based on the input signal.

4. The robot according to claim 3, wherein the sensor includes a microphone configured to detect a sound and generate the input signal based on the detected sound, and
the processor is configured to determine the first linguistic information based on the input signal.

5. The robot according to claim 4, wherein the processor is configured to perform speech recognition with respect to the input signal to generate recognized speech, and acquire the first phonological information including the recognized speech as the first linguistic information.

6. The robot according to claim 4, wherein the processor is configured to perform speech recognition with respect to the input signal to generate recognized speech, and acquire the first phonological information including a response to the recognized speech as the first linguistic information.

7. The robot according to claim 3, wherein the sensor comprises a camera configured to detect incident light and generate an image signal as the input signal, and
the processor is configured to determine the first linguistic information based on the image signal, and acquire the first phonological information including the first linguistic information.

8. The robot according to claim 7, wherein the processor is configured to perform letter recognition with respect to the image signal to generate a recognized letter, and acquire the first phonological information including the recognized letter as the first linguistic information.

9. The robot according to claim 7, wherein the processor is configured to perform object recognition with respect to the image signal to generate a recognized object, and acquire the first phonological information including first linguistic information representing the recognized object.

10. The robot according to claim 1, wherein the processor is configured to identify a first emotion parameter corresponding to the at least one portion of the phoneme of the plurality of phonemes in the first phonological information, and generate the second phonological information based on the identified first, emotion parameter.

11. The robot according to claim 10, wherein the processor is configured to generate the second phonological information including a second emotion parameter similar to the first emotion parameter.

12. The robot according to claim 10, wherein the non-transitory computer readable medium is configure to store a table that correlates a phoneme of the plurality of phonemes and the first emotion parameter, wherein
the processor is configured to identify the first emotion parameter based on the table.

13. The robot according to claim 10, wherein the non-transitory computer readable medium is configured to store a table that correlates a phoneme of the plurality of phonemes and the first emotion parameter, wherein
the processor is configured to generate the second phonological information using the table.

14. The robot according to claim 10, wherein the sensor comprises a microphone configured to detect a sound and generate the input signal based on the detected sound, and
the processor is configured to acquire the first phonological information using speech recognition with respect to the input signal.

15. The robot according to claim 1, wherein the processor is configured to generate the second phonological information having a predetermined number of syllables or less, regardless of a number of syllables in the first phonological information.

16. The robot according to claim 15, wherein the processor is configured to generate the second phonological information formed of two syllables.

17. A speech synthesizing system comprising:
a non-transitory computer readable medium configured to store instructions; and
a processor connected to the non-transitory computer readable medium, wherein the processor is configured to execute the instructions for:
acquiring first phonological information formed of a plurality of phonemes;
generating second phonological information, different from the first phonological information, based on at least one portion a phoneme of the plurality of phonemes included in the first phonological information; and
synthesizing speech in accordance with the second phonological information.

18. The speech synthesizing system according to claim 17, wherein the processor is further configured to transmit instructions for outputting the synthesized speech.

19. A speech output method, comprising
acquiring first phonological information formed of a plurality of phonemes;
generating second phonological information, different from the first phonological information, based on at least one portion a phoneme of the plurality of phonemes included in the first phonological information;
synthesizing speech in accordance with the second phonological information; and
outputting the synthesized speech.

20. The method according to claim 19, wherein
generating the second phonological information comprises generating the second phonological information including second linguistic information having a second amount of linguistic information, and
acquiring the first phonological information comprises acquiring acquire first linguistic information of the first phonological information having a first amount of linguistic information, wherein the second amount of linguistic information is less than the first amount of linguistic information.
